(19) United States
(12) Patent Application Publication
(10) Pub. No.: US 2025/0245629 A1
(43) Pub. Date: Jul. 31, 2025

(54) Quantum-Assisted Real-Time Distributed Service Management

(71) Applicant: Bank of America Corporation, Charlotte, NC (US)

(72) Inventors: Suryanarayana Adivi, Hyderabad (IN); Venkata Karthik Ryali, Hyderabad (IN); Pushkar Taneja, Hyderabad (IN); Durga Prasad Kutthhumolu, Hyderabad (IN)

(21) Appl. No.: 18/422,104

(22) Filed: Jan. 25, 2024

(51) Int. Cl. G06Q 10/20; H04L 43/0852

(52) U.S. Cl. CPC G06Q 10/20; H04L 43/0852

(57) ABSTRACT

Arrangements for resource balancing and inferential service are provided. A computing platform may receive monitoring data including current availability data of a plurality of computing resources associated with different types of computing systems, and a first request including parameters of the first request. A machine learning model may receive, as inputs, the parameters of the first request and the monitoring data and may be executed to output a particular type of computing system to process the first request. The computing platform may determine whether a delay exists with the particular type of computing system. If not, the first request may be sent to the particular type of computing system for processing. If a delay exists, the delay may be evaluated to identify a cause and a remediation action may be identified and executed. The first request may then be sent to the particular type of computing system for processing.

### BACKGROUND

Aspects of the disclosure relate to electrical computers, systems, and devices for resource optimization, workload balancing and system resolution.

Large enterprise organizations often operate multiple distributed systems to perform various operations. However, as with all systems, volume of requests, numbers of users, system or network availability, and the like, may vary, thereby causing potential delays in processing requests for data. Current systems address these delays in data or service by having development teams instantiate one or more services ahead of time. However, this can lead to capacity issues for servers and other computing resources that may further impact performance. Accordingly, it would be advantageous to provide a resource optimization and workload balancing system that not only identifies an appropriate type of computing technique, resource or system to address a request, but also can identify a root cause of a delay and execute an identified resolution to resolve the delay and improve performance.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical issues associated with resource optimization and workload balancing.

In some examples, a computing platform may train a machine learning model. The machine learning model may be trained using historical data including data related to volume of requests, number of active users, and the like. The machine learning model may be trained to output a recommended type of computing resource based on parameters of a request input to the machine learning model.

In some examples, the computing platform may receive monitoring data including current availability data of a plurality of computing resources associated with different types of computing systems. The computing platform may receive a first request including parameters of the first request.

In some examples, the machine learning model may receive, as inputs, the parameters of the first request and the monitoring data and may be executed to output a particular type of computing system to process the first request. In some arrangements, the computing platform may determine whether a delay exists in computing resources associated with the particular type of computing system output by the machine learning engine. If not, the first request may be sent to the computing resources of the particular type of computing system for processing.

If a delay exists, the delay may be evaluated to identify a cause. In some examples, the computing platform may identify one or more remediation actions and may execute the remediation actions to address the delay. The first request may then be sent to the computing resources associated with the particular type of computing system for processing.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for resource balancing and

inferential service in accordance with one or more aspects described herein;

FIGS. 2A-2D depict an illustrative event sequence for resource balancing and inferential service in accordance with one or more aspects described herein;

FIG. 3 depicts an illustrative method for resource balancing and inferential service in accordance with one or more aspects described herein; and

FIG. 4 illustrates one example environment in which various aspects of the disclosure may be implemented in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed herein, delays in enterprise organization systems can be caused by a variety of factors and can impact system performance and customer satisfaction. For example, online shopping sites may be impacted by high volume shopping days or seasons. In another example, gaming platforms may experience buffering delays based on high volume of use. In still another example, application programming interface (API) delays or failures, as well as external system or network issues, can also cause delays that may prevent systems from processing requests within an expected time period.

Accordingly, aspects described herein provide for a dynamic system to identify a particular type of computing resources to optimize processing of requests and balance workloads. For instance, a system may use machine learning to evaluate a request to identify a particular type of computing system or type of computing resources (e.g., classical computing, quantum computing, hybrid computing) to efficiently process the request. In some examples, if no delays are detected, the system may dynamically send the request to the identified type of computing resources for processing. If a delay is detected in the identified computing resources, the system may review historical data to identify a cause of the delay and may automatically execute a resolution to the delay prior to sending the request for processing.

These and various other arrangements will be discussed more fully below.

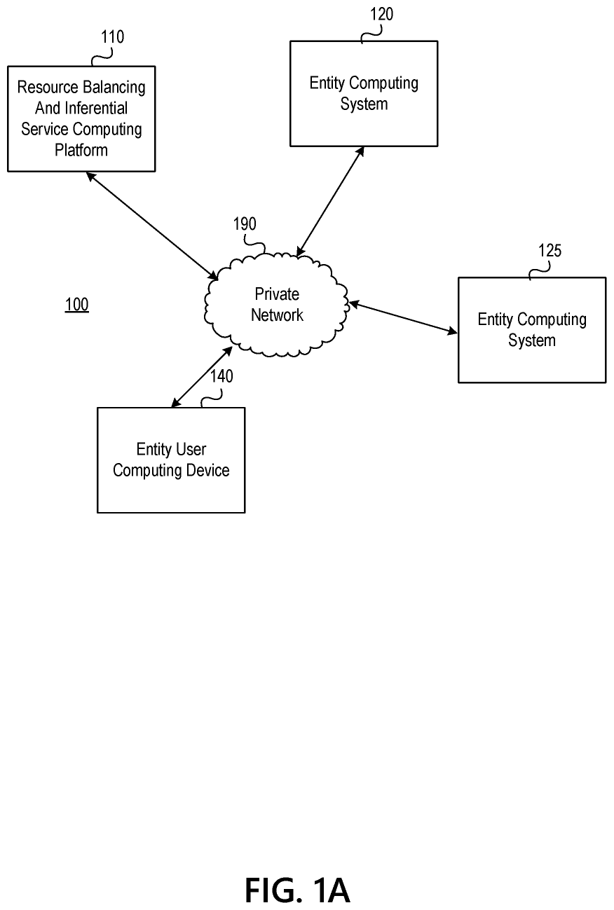

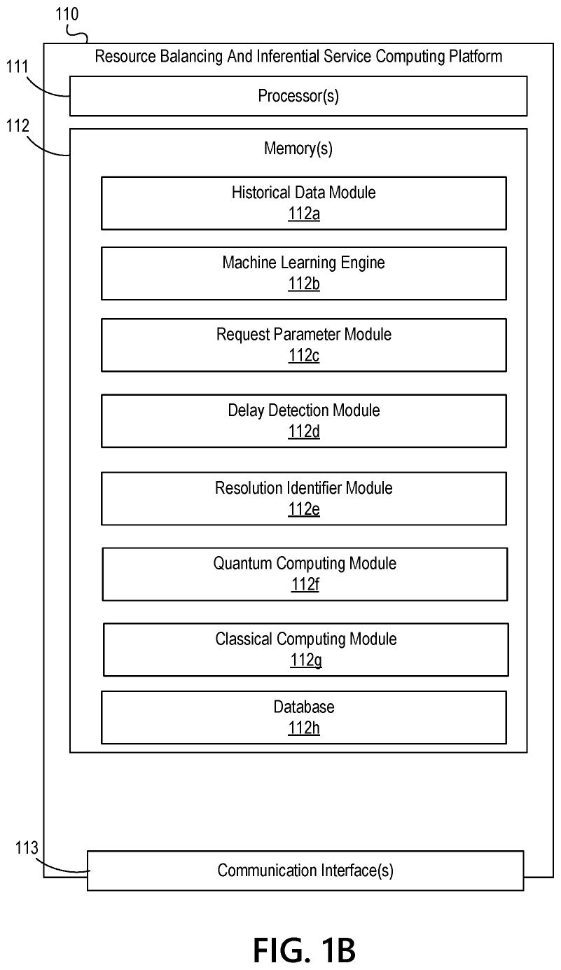

FIGS. 1A-1B depict an illustrative computing environment for implementing quantum-assisted real-time distributed service management in accordance with one or more aspects described herein. Referring to FIG. 1A, computing environment 100 may include one or more computing devices and/or other computing systems. For example, computing environment 100 may include resource balancing and inferential service computing platform 110, entity computing system 120, entity computing system 125 and entity user computing device 140. Although two entity computing systems 120, 125 and one entity user computing device 140 are shown, any number of systems or devices may be used without departing from the invention.

Resource balancing and inferential service computing platform 110 may be or include one or more computing devices (e.g., servers, server blades, or the like) and/or one or more computing components (e.g., memory, processor, and the like) and may be configured to dynamically, and in real-time, assess requests for processing to identify an optimized type of computing resources to process the request, evaluate resources for delays and resolve any issues causing delays. For instance, resource balancing and inferential service computing platform 110 may train a machine learning model. The machine learning model may be trained using historical data related to types of processing requests, parameters of processing requests, volume of requests, number of active users on a system, and the like, to identify or predict a type of computing resources or system (e.g., classical, quantum or hybrid) to process a particular request. In some examples, parameters of a request, as well as current resource information (e.g., real-time data related to volume of requests, network or system availability, number of active users, and the like) may be input to the machine learning model. The model may be executed and may output a particular type of computing resources to process the request.

For instance, if the request is for a simple calculation or volume of requests is low, classical computing may be identified to process the transaction. If the request includes a sensitive data, a complex calculation and/or volume of users is high, quantum computing may be identified. In another example, if the request includes both structured and unstructured data, a hybrid of both classical computing and quantum computing may be identified by the machine learning model. The examples provided are merely some examples and other examples may be used without departing from the invention.

In some examples, resource balancing and inferential service computing platform 110 may evaluate or monitor current computing resources to identify current delays (e.g., in real-time). If no delays are detected, resource balancing and inferential service computing platform 110 may send the request for processing to the identified computing resources. If one or more delays are detected, resource balancing and inferential service computing platform 110 may identify a cause of the delay, identify a resolution and automatically execute the identified resolution to resolve any delay. In some examples, machine learning may be used to identify the cause of the delay and the resolution. Once resolved, the request may be sent to the identified computing resources for processing.

Entity computing system 120 and/or entity computing system 125 may be or include one or more computing devices (e.g., servers, server blades, or the like) and/or one or more computing components (e.g., memory, processor, and the like) and may be configured to host or execute one or more enterprise organization applications or systems. For instance, entity computing system 120 and/or entity computing system 125 may host or execute internal or customer-facing applications or systems that may be accessed by one or more users via a network, such as a private network, public network, or the like.

Entity user computing device 140 may be or include a computing device such as a desktop computer, laptop computer, tablet, smartphone, wearable device, and the like, that is associated with a user (e.g., an employee) of the enterprise organization. Entity user computing device 140 may communicate with resource balancing and inferential service computing platform 110 to receive notifications of identified and/or resolved delays, receive notifications related to selected or identified computing resources for processing requests, and the like.

As mentioned above, computing environment 100 also may include one or more networks, which may interconnect one or more of resource balancing and inferential service computing platform 110, entity computing system 120, entity computing system 125, and/or entity user computing device 140. For example, computing environment 100 may include network 190. Network 190 may include one or more sub-networks (e.g., Local Area Networks (LANs), Wide Area Networks (WANs), or the like). Network 190 may be associated with a particular organization (e.g., a corporation, financial institution, educational institution, governmental institution, or the like) and may be a private network interconnecting one or more computing devices associated with the organization. For example, resource balancing and inferential service computing platform 110, entity computing system 120, entity computing system 125, and/or entity user computing device 140 may be associated with an enterprise organization (e.g., a financial institution), and network 190 may be associated with and/or operated by the organization, and may include one or more networks (e.g., LANs, WANs, virtual private networks (VPNs), or the like) that interconnect resource balancing and inferential service computing platform 110, entity computing system 120, entity computing system 125, and/or entity user computing device 140 and one or more other computing devices and/or computer systems that are used by, operated by, and/or otherwise associated with the organization. Additionally or alternatively, network 190 may be a public network, such as the internet, that may connect the systems and devices described.

Referring to FIG. 1B, resource balancing and inferential service computing platform 110 may include one or more processors 111, memory 112, and communication interface 113. A data bus may interconnect processor(s) 111, memory 112, and communication interface 113. Communication interface 113 may be a network interface configured to support communication between resource balancing and inferential service computing platform 110 and one or more networks (e.g., network 190, or the like). Memory 112 may include one or more program modules having instructions that when executed by processor(s) 111 cause resource balancing and inferential service computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of resource balancing and inferential service computing platform 110 and/or by different computing devices that may form and/or otherwise make up resource balancing and inferential service computing platform 110.

For example, memory 112 may have, store and/or include historical data module 112a. Historical data module 112a may store instructions and/or data that may cause or enable resource balancing and inferential service computing platform 110 to receive historical data related to various system and/or request parameters, such as request volume, number of active users, frequency of requests, and other metrics. This data may be used to train one or more machine learning models.

For instance, resource balancing and inferential service computing platform 110 may have, store and/or include machine learning engine 112b. Machine learning engine 112b may store instructions and/or data that may cause or enable the resource balancing and inferential service computing platform 110 to train, execute, update and/or validate one or more machine learning models. In some examples, may be based on regression, classification or other suitable techniques. The one or more machine learning models may be trained using the historical data received by historical data module 112a to detect patterns or sequences in previous parameter data. Current request parameters may be input to the trained machine learning model and the model may be executed to output a recommended type of computing or processing for the request. For instance, based on request parameters, the machine learning model may output a recommendation for quantum computing, classical computing, or a hybrid computing which may include both quantum and classical computing.

Resource balancing and inferential service computing platform 110 may further have, store and/or include request parameter module 112c. Request parameter module 112c may receive current requests for processing and may extract one or more parameters of the request (e.g., complexity, speed or timing restraints, and the like). In some examples, request parameter module 112c may also receive current system status or parameter information (e.g., current volume of requests, current active users, or the like). The request parameter module 112c may provide the identified parameters to the one or more machine learning models as inputs to output a type of computing system to process the request.

Resource balancing and inferential service computing platform 110 may further have, store and/or include delay detection module 112d. Delay detection module 112d may store instructions and/or data that may cause or enable the resource balancing and inferential service computing platform 110 to evaluate a current status of various systems (e.g., quantum computing systems, classical computing systems, and the like) and identify one or more delays or issues with the one or more systems (e.g., API delays, volume delays, or the like).

Resource balancing and inferential service computing platform 110 may further have, store and/or include resolution identifier module 112e. Resolution identifier module 112e may store instructions and/or data that may cause or enable resource balancing and inferential service computing platform 110 to identify one or more resolutions to remedy any detected delays. For instance, based on historical delay and remediation data, one or more resolutions to a detected delay may be identified by resolution identifier module 112e. In some examples, machine learning may be used to identify a resolution to an identified delay. For instance, historical delay and resolution data may be used to train a machine learning model to identify patterns or sequences in data related to current delays in order to identify a resolution. In some examples, an identified resolution may be automatically implemented or executed (e.g., without user interaction) to remediate a delay.

Resource balancing and inferential service computing platform 110 may have, store and/or include quantum computing module 112f. Quantum computing module 112f may store instructions and/or data that may cause or enable resource balancing and inferential service computing platform 110 to process, using quantum computing hardware and techniques, a received request. For instance, based on a recommended computing system output by the machine learning model, requests identified for quantum computing may be processed by the quantum computing module 112f. In some examples, quantum computing module 112f may include photonic quantum computing hardware to enable processing requests using quantum computing techniques but without requiring particular environmental conditions for the quantum hardware (e.g., processes or computations may be performed at room temperature rather than requiring very low temperature for an entire quantum process). Photonics-based quantum computing may also provide improved scalability over other quantum techniques. In some examples, quantum computing module 112f may include advanced quantum processors, highly stable quantum bits (qubits), and optimized quantum gates tailored to handle processing of massive amounts of data to provide scalability, reliability and efficiency.

Resource balancing and inferential service computing platform 110 may further have, store and/or include classical computing module 112g. Classical computing module 112g may store instructions and/or data that may cause or enable resource balancing and inferential service computing platform 110 to process, using classical computing techniques and hardware, a received request. For instance, based on a recommended computing system output by the machine learning model, requests identified for classical computing maybe processed by the classical computing module 112g. In some examples, classical computing module 112g may include a classical computing layer with a single neuron that uses a sigmoid activation function.

In examples in which the machine learning model outputs a recommendation for hybrid processing, a request may be processed using both quantum computing module 112f and classical computing module 112g.

Resource balancing and inferential service computing platform 110 may further have, store and/or include database 112h. Database 112h may store data related to requests and request parameters, identified delays, identified resolutions, machine learning model outputs of recommended computing systems or types, and/or other data that enables performance of aspects described herein by the resource balancing and inferential service computing platform 110.

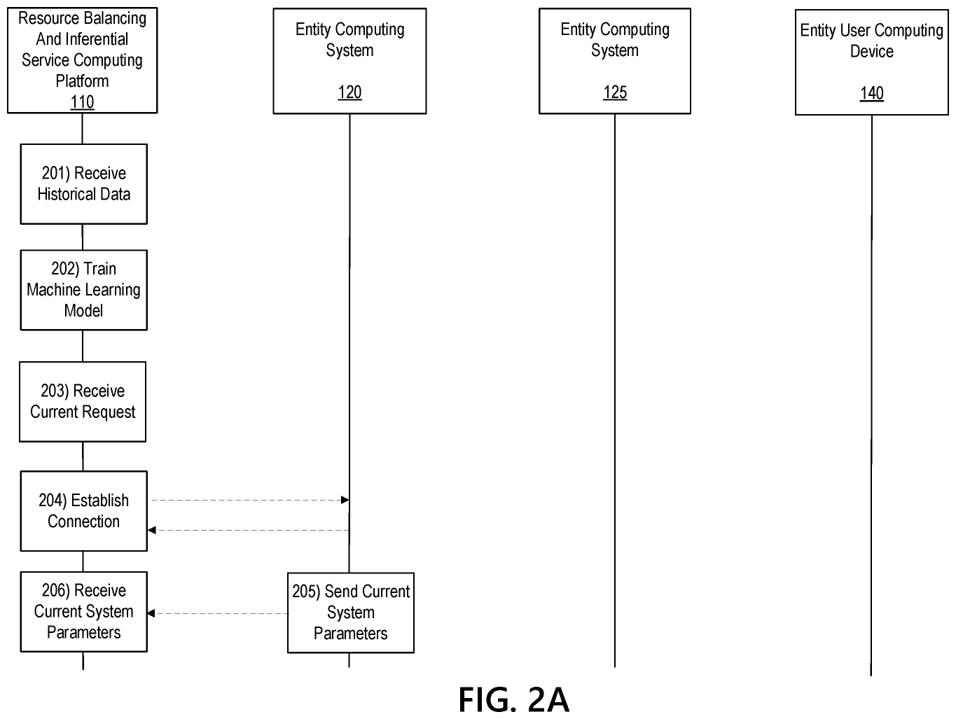

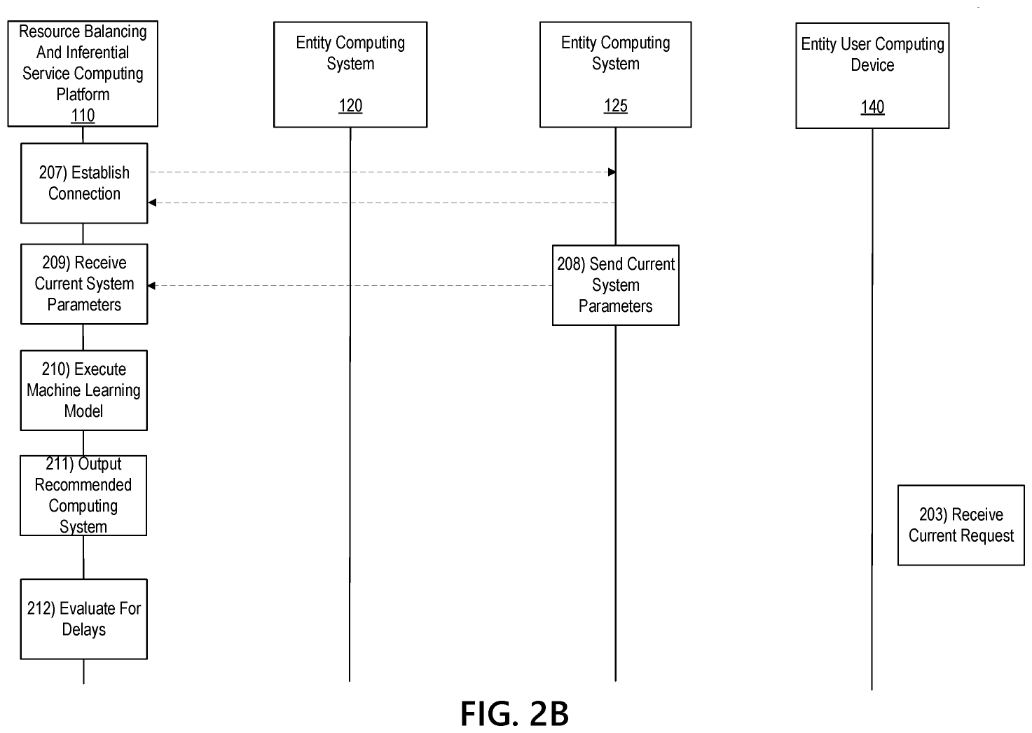

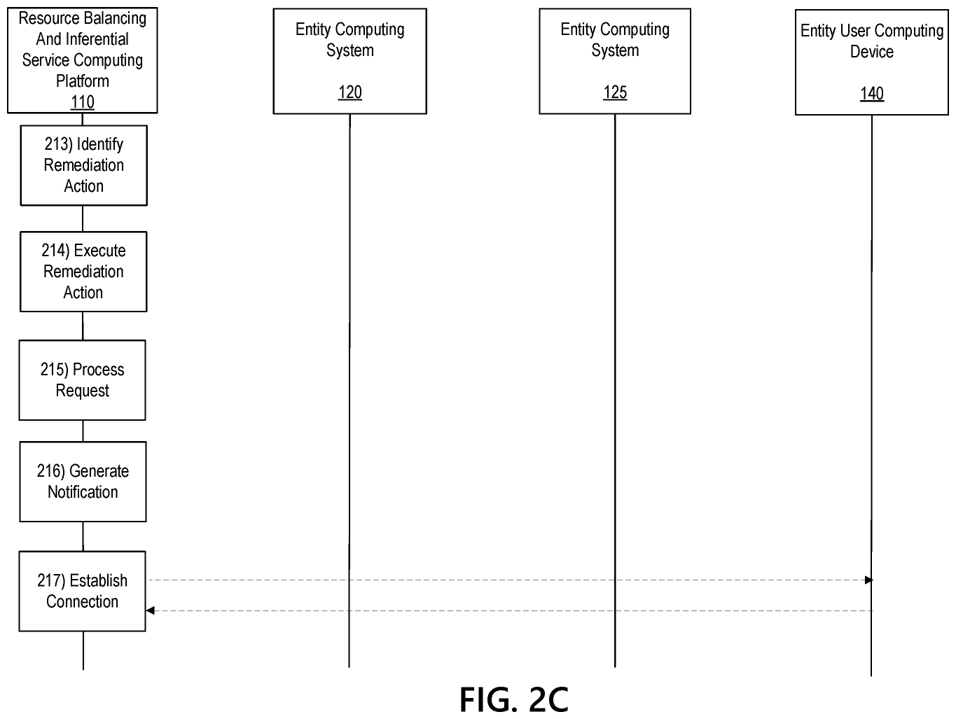

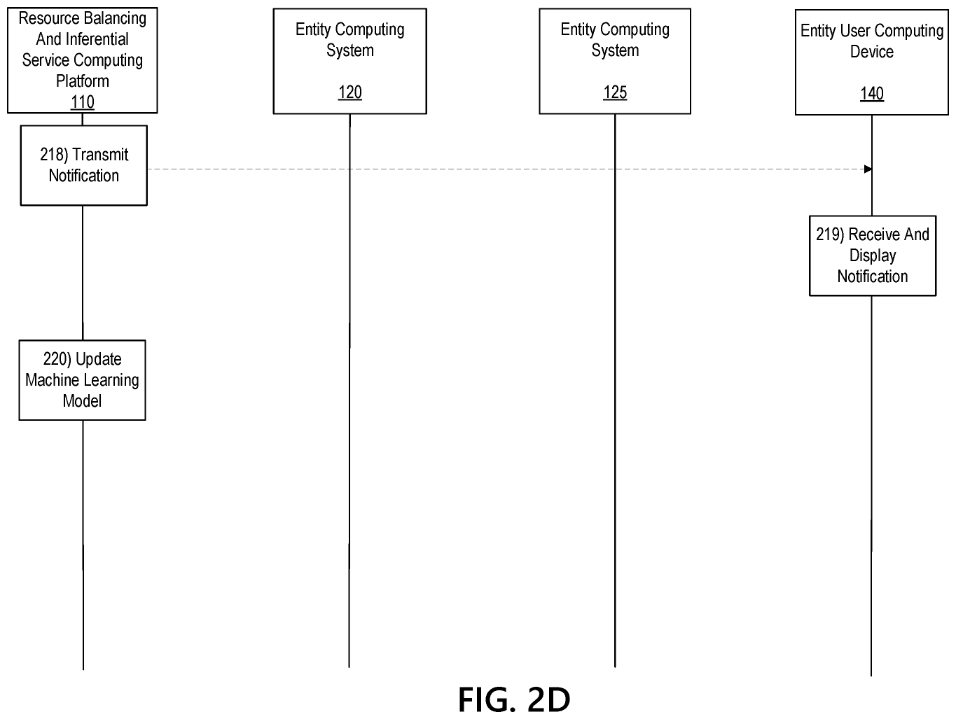

FIGS. 2A-2D depict one example illustrative event sequence for quantum-assisted real-time distributed service management in accordance with one or more aspects described herein. The events shown in the illustrative event sequence are merely one example sequence and additional events may be added, or events may be omitted, without departing from the invention. Further, one or more processes discussed with respect to FIGS. 2A-2D may be performed in real-time or near real-time.

With reference to FIG. 2A, at step 201, resource balancing and inferential service computing platform 110 may receive historical data. For instance, resource balancing and inferential service computing platform 110 may receive historical data associated with different volumes of requests, numbers of active users, and the like. In some examples, the historical data may include system delay issues and/or status as well as remediation actions to address identified delays.

At step 202, resource balancing and inferential service computing platform 110 may train a machine learning model. For instance, resource balancing and inferential service computing platform 110 may train a machine learning model using the received historical data. In training the machine learning model, resource balancing and inferential service computing platform 110 may identify patterns or sequences in the historical data that may enable the machine learning model to analyze parameters of a current request and output a recommend computing system or type to process the request. In some examples, the machine learning model may be further trained to receive detected system or device delay information and output, based on patterns or sequences in the historical data, a remediation action to address the identified delay.

In some examples, the machine learning model may be or include one or more supervised learning models (e.g., decision trees, bagging, boosting, random forest, neural networks, linear regression, artificial neural networks, logical regression, support vector machines, and/or other models), unsupervised learning models (e.g., clustering, anomaly detection, artificial neural networks, and/or other models), knowledge graphs, simulated annealing algorithms, hybrid quantum computing models, and/or other models. In some examples, training the machine learning model may include training the model using labeled data (e.g., labeled data identifying computing systems used to process historical requests, detected delays and remediation actions, and the like) and/or unlabeled data.

At step 203, resource balancing and inferential service computing platform 110 may receive a current request for processing. The current request may include one or more parameters that may be extracted by the resource balancing and inferential service computing platform 110. For instance, a complexity of the request, speed or timing considerations for the request, and the like, may be extracted.

At step 204, resource balancing and inferential service computing platform 110 may establish a connection with entity computing system 120. For instance, resource balancing and inferential service computing platform 110 may establish a first wireless connection with entity computing system 120. Upon establishing the first wireless connection, a communication session may be initiated between resource balancing and inferential service computing platform 110 and entity computing system 120.

At step 205, entity computing system 120 may send current system parameters or status information to the resource balancing and inferential service computing platform 110. For instance, current availability of resources, current volume of request data, current number of active users, and the like, may be sent by the entity computing system 120 to the resource balancing and inferential service computing platform 110. In some examples, additional data related to time of day, day of week, time of year, or the like, that may be relevant to understand or predict increased volumes may be sent (e.g., an online shopping system may have a high volume of users and requests during a busy holiday shopping season).

At step 206, resource balancing and inferential service computing platform 110 may receive the current system parameters sent by entity computing system 120.

With reference to FIG. 2B, at step 207, resource balancing and inferential service computing platform 110 may establish a connection with entity computing system 125. For instance, resource balancing and inferential service computing platform 110 may establish a second wireless connection with entity computing system 125. Upon establishing the second wireless connection, a communication session may be initiated between resource balancing and inferential service computing platform 110 and entity computing system 125.

At step 208, entity computing system 125 may send current system parameters or status information to the resource balancing and inferential service computing platform 110. For instance, current availability of resources, current volume of request data, current number of active users, and the like, may be sent by the entity computing system 125 to the resource balancing and inferential service computing platform 110.

Although the arrangements shown and described illustrate receiving current system parameters from two entity computing systems 120, 125, in some examples, data may be received from more or fewer systems without departing from the invention.

At step 209, resource balancing and inferential service computing platform 110 may receive the current system parameters sent by entity computing system 120.

At step 210, resource balancing and inferential service computing platform 110 may execute a machine learning model. For instance, resource balancing and inferential service computing platform 110 may use, as inputs, the parameters of the request extracted from the request, as well as the current system parameters received from entity computing system 120 and entity computing system 125 and, upon execution of the machine learning model, the model may output a recommended type of computing system for processing the request at step 211. For instance, in analyzing the request and system parameters, the machine learning model may identify patterns or sequences in the parameters that may indicate a recommended type of computing system to process the request (e.g., quantum, classical, hybrid) (e.g., based on training data used to train the machine learning model).

At step 212, resource balancing and inferential service computing platform 110 may evaluate current system parameters to identify any delays in functions of the systems. For instance, if one or more computing resources is experiencing an API issue, a high volume of requests, a high number of users, or the like, that may be causing a delay, the resource balancing and inferential service computing platform 110 may identify the existing delay. If no delays exist, the process may proceed to step 215 in FIG. 2C.

If one or more delays are identified, the process may proceed to step 213 in FIG. 2C. At step 213, resource balancing and inferential service computing platform 110 may identify one or more remediation actions to address the identified delay. In some examples, machine learning may be used to evaluate the current delay and identify, based on training data, one or more remediation actions to address the delay.

At step 214, the identified remediation action may be executed by the resource balancing and inferential service computing platform 110. For instance, resource balancing and inferential service computing platform 110 may automatically (e.g., without user input) execute the identified remediation action to address the identified delay.

At step 215, after a delay has been addressed, or if no delays are detected, the request may be processed. For instance, resource balancing and inferential service computing platform 110 may process the request using the type of computing system output by the machine learning model (e.g., quantum, classical, hybrid). In some examples, if the machine learning output includes a recommendation for quantum computing (e.g., the request is complex, includes vast amounts of data, must be performed quickly, or the like based on the parameters of the request), the resource balancing and inferential service computing platform 110 may process the request using quantum computing resources (e.g., photonic-based quantum hardware, and the like). Alternatively, if the machine learning output includes a recommendation for classical computing (e.g., the request is not complex, includes standard amounts of data, does not need to be performed within certain time constraints, or the like, based on the parameters of the request), the resource balancing and inferential service computing platform 110 may process the request using classical computing techniques and hardware. In still other examples, if the machine learning model outputs a recommendation for hybrid processing (e.g., both quantum and classical computing), the resource balancing and inferential service computing platform may process portions of the request using quantum computing techniques and hardware and portions of the request using classical computing techniques and hardware.

At step 216, resource balancing and inferential service computing platform 110 may generate a notification. For instance, resource balancing and inferential service computing platform 110 may generate a notification indicating that one or more delays were identified and remediated, that a request was processed, type of computing system used to process the request, and the like.

At step 217, resource balancing and inferential service computing platform 110 may establish a connection with entity user computing device 140. For instance, resource balancing and inferential service computing platform 110 may establish a third wireless connection with entity user computing device 140. Upon establishing the third wireless connection, a communication session may be initiated between resource balancing and inferential service computing platform 110 and entity user computing device 140.

With reference to FIG. 2D, at step 218, resource balancing and inferential service computing platform 110 may transmit or send the notification to the entity user computing device 140. In some examples, the notification may be sent during the communication session initiated upon establishing the third wireless connection. In some arrangements, transmitting or sending the notification may cause the entity user computing device 140 to display the notification on a display of the entity user computing device 140.

At step 219, entity user computing device 140 may receive and display the notification.

At step 220, resource balancing and inferential service computing platform 110 may update and/or validate the machine learning model. For instance, the machine learning model may be updated and/or validated using a dynamic feedback loop based on processing the request with the recommended computing system, detection of delays, detection and execution of remediation actions, and the like. Accordingly, the machine learning model may be continuously updated to improve accuracy of outputs.

In some instances, resource balancing and inferential service computing platform 110 may continuously update, validate, refine, or the like, the machine learning model. In some examples, the resource balancing and inferential service computing platform 110 may maintain an accuracy threshold for the machine learning model and may pause refinement (through the dynamic feedback loop) of the model if the corresponding accuracy is identified as greater than the accuracy threshold. Further, if the accuracy is at or below the accuracy threshold, the resource balancing and inferential service computing platform 110 may resume refinement of the model through the corresponding dynamic feedback loop.

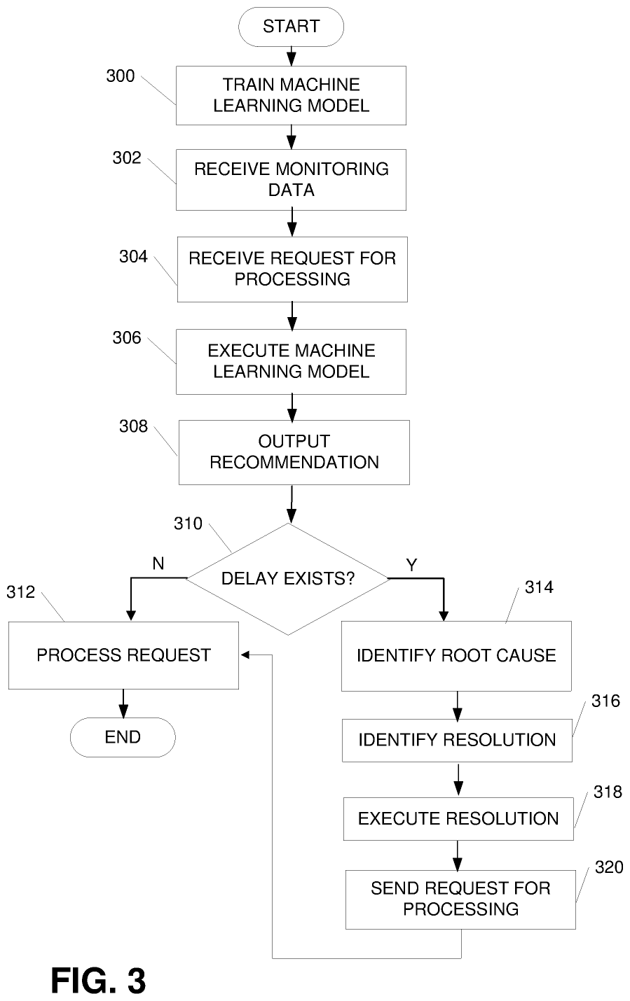

FIG. 3 is a flow chart illustrating one example method of resource balancing and inferential service in accordance with one or more aspects described herein. The processes illustrated in FIG. 3 are merely some example processes and functions. The steps shown may be performed in the order shown, in a different order, more steps may be added, or one or more steps may be omitted, without departing from the invention. In some examples, one or more steps may be performed simultaneously with other steps shown and described. One of more steps shown in FIG. 3 may be performed in real-time or near real-time.

At step 300, a computing platform, such as resource balancing and inferential service computing platform 110, may train a machine learning model. For instance, the machine learning model may be trained using historical data related to volume of requests, number of active users, parameters of requests, network conditions, and the like.

At step 302, the computing platform may receive monitoring data. For instance, the computing platform may receive, in real-time, monitoring data indicating current network, system, device, and the like, conditions or status of various computing resources (e.g., classical computing resources, quantum computing resources, hybrid resource). The monitoring data may include current volume of requests, current number of active users, current network or system availability, service execution sequences, or the like.

At step 304, the computing platform may receive a request for processing. For instance, the computing platform may receive a request to provide data to a user via one or more entity systems, such as entity computing system 120, entity computing system 125, or the like. The computing platform 110 may extract parameters of the request (e.g., type of data, APIs associated with the request, type of calculations to perform, speed of processing or timing constraints, and the like).

At step 306, the computing platform may execute the machine learning model. For instance, the computing platform 110 may input, to the machine learning model, the parameters of the request, as well as the current monitoring or system parameter data. The computing platform may execute the model and the model may output a type of computing resources to process the request (e.g., classical computing, hybrid computing, quantum computing) at step 308.

At step 310, the computing platform 110 may determine whether a delay exists in the identified computing resources. For instance, the computing platform may analyze the monitoring data to identify or detect current delays in one or more computing resources (e.g., API failures, high volume of requests, high number of users, and the like).

If no delay is detected, at step 312, the request for processing may be sent to the identified type of computing resources for processing and the request may be processed.

If, at step 310, a delay is detected, the computing platform 110 may identify a cause of the delay at step 314. For instance, the machine learning model may be used to identify, from historical data, a cause of the identified delay (e.g., insufficient memory, resource constraints, dependency issue, system failure, network failure, external data issue, software issue, or the like). If a cause is identified, the computing platform may identify a resolution to the identified cause of the delay or a remediation action to address the delay at step 316. For instance, machine learning may be used to identify, from historical data, resolutions successfully used to remedy similar delays (e.g., add additional memory, modify connectivity pattern, batch execution vs. continuous execution, update software or execute patch, or the like) and, at step 318, may automatically execute the identified resolution.

At step 320, the computing platform 110 may send the request for processing to the identified type of computing resources for processing and the request may be processed.

Accordingly, as discussed herein, the arrangements described provide for dynamic, efficient, real-time workload optimization and resource balancing. By using machine learning to identify appropriate types of computing resources to process requests, the system may dynamically process requests while avoiding delays that may cause requests to be processed outside of an expected time frame.

As discussed, various challenges can arise that provide delays in one or more systems. The arrangements described herein enable efficient real-time workload and resource balancing to avoid delays and, if delays occur, quickly identify a cause and address the delay. For instance, delays in an API execution process may make a system incapable of processing a request within a predetermined time period (e.g., a required time period per one or more standards of an enterprise organization. This can lead to customer dissatisfaction due to delays in providing requested data to users. Accordingly, the arrangements described herein may quickly and efficiently identify and address any delays, or efficiently balance workload and resources in real-time to avoid delays.

In another example, a customer call center may have a large volume of calls or requests which may lead to processing excessive volumes of data. This can cause delays in retrieving data that may be addressed using the workload balancing aspects described herein.

In still another example, online shopping platforms may see increased volume during busy holiday shopping periods. During these times, upload and/or download speeds may be slow due to the excessive volume of data being processed and associated requests. Conventional systems may not be configured to handle the volume of data being processed or the volume of requests but by leveraging quantum computing, the arrangements described herein may efficiently identify appropriate computing resources to handle the volume.

In still another example, financial trading platforms may see high volume of requests that may cause the platform to not respond properly and have delays in uploading data, processing trades, and the like. In some examples, real-time market data may be delayed. Accordingly, the arrangements described herein enable real-time load balancing to avoid such delays and, if delays occur, quickly and efficiently address the delays.

The process of real-time quantum computing with dynamic time and services management with a unique quantum infrastructure may offer advanced computational capabilities, enhanced decision-making, improved security, and optimized performance for operations.

The system may collect data on various parameters, such as request volume, active users, frequency of requests, and other relevant metrics. This data may be used to train the machine learning/artificial intelligence model and build predictive capabilities. The collected data may be used to train the model, which can be based on regression, classification, or other suitable techniques. The system incorporates a unique quantum infrastructure that may include quantum processors, qubits, and associated quantum computing hardware. This infrastructure may provide the necessary computational power to perform quantum computations. Given a new set of input parameters (e.g., current request volume, active user count, etc.), the model may predict whether classical or quantum computing is more suitable for the workload.

The prediction may be based on the patterns and relationships learned during the training phase. Based on the prediction, the system may dynamically decide whether to execute the workload using classical computing, quantum computing or hybrid computing. The process may involve performing quantum computations in real-time, enabling immediate decision-making and rapid response in the system.

The process may use quantum computing to enhance the accuracy and efficiency of calculations. Quantum computing techniques, such as quantum machine learning algorithms, can process and analyze large volumes of data to make predictions in real-time. This novel integration of quantum computing may improve decision-making capabilities and enables advanced analytics in the system.

The combination of real-time quantum computing, dynamic time management, inferential service, and a unique quantum infrastructure enables faster, more efficient, and secure processing in portfolio management. In some examples, classical layer with a single neuron that uses the sigmoid activation function may be used. This layer may take inputs from the quantum layer, so it will accept two inputs. It may treat the quantum layer as if it were a classical layer with two neurons.

Further, the system may continuously monitor the performance and outcomes of the executed workload. This information may be fed back into the machine learning model to refine and improve its predictions over time. The model adapts and learns from real-time data to make more accurate predictions in the future.

Accordingly, the arrangements described herein provide a high level of security, including access control, encryption, and intrusion detection and prevention mechanisms. To ensure the security and accuracy of the system, multi-factor authentication may be implemented to verify user identity and access privileges.

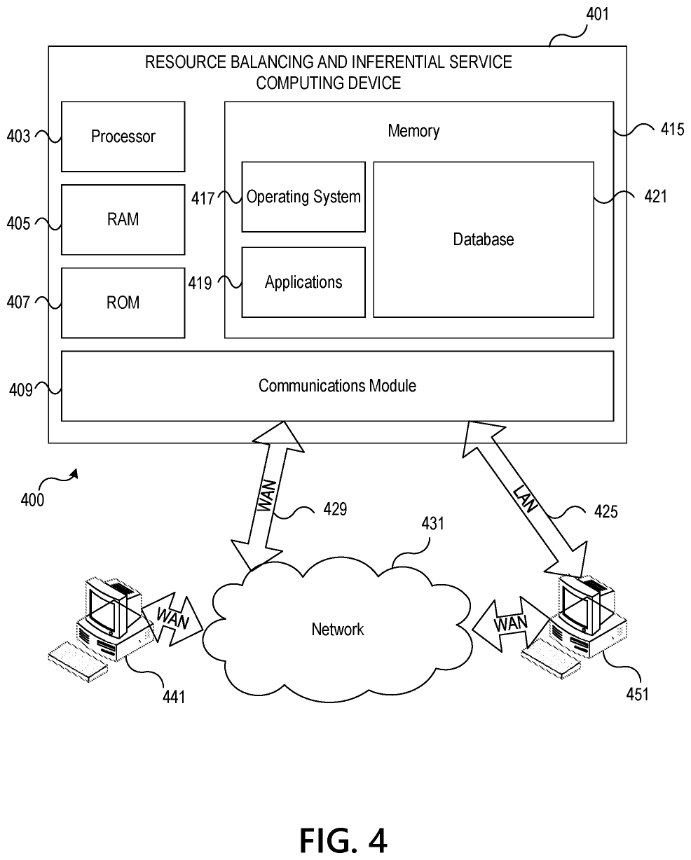

FIG. 4 depicts an illustrative operating environment in which various aspects of the present disclosure may be implemented in accordance with one or more example embodiments. Referring to FIG. 4, computing system environment 400 may be used according to one or more illustrative embodiments. Computing system environment 400 is only one example of a suitable computing environment and is not intended to suggest any limitation as to the scope of use or functionality contained in the disclosure. Computing system environment 400 should not be interpreted as having any dependency or requirement relating to any one or combination of components shown in illustrative computing system environment 400.

Computing system environment 400 may include resource balancing and inferential service computing device 401 having processor 403 for controlling overall operation of resource balancing and inferential service computing device 401 and its associated components, including Random Access Memory (RAM) 405, Read-Only Memory (ROM) 407, communications module 409, and memory 415. Resource balancing and inferential service computing device 401 may include a variety of computer readable media. Computer readable media may be any available media that may be accessed by resource balancing and inferential service computing device 401, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by resource balancing and inferential service computing device 401.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on resource balancing and inferential service computing device 401. Such a processor may execute computer-executable instructions stored on a computer-readable medium.

Software may be stored within memory 415 and/or storage to provide instructions to processor 403 for enabling resource balancing and inferential service computing device 401 to perform various functions as discussed herein. For example, memory 415 may store software used by resource balancing and inferential service computing device 401, such as operating system 417, application programs 419, and associated database 421. Also, some or all of the computer executable instructions for resource balancing and inferential service computing device 401 may be embodied in hardware or firmware. Although not shown, RAM 405 may include one or more applications representing the application data stored in RAM 405 while resource balancing and inferential service computing device 401 is on and corresponding software applications (e.g., software tasks) are running on resource balancing and inferential service computing device 401.

Communications module 409 may include a microphone, keypad, touch screen, and/or stylus through which a user of resource balancing and inferential service computing device 401 may provide input, and may also include one or more of a speaker for providing audio output and a video display device for providing textual, audiovisual and/or graphical output. Computing system environment 400 may also include optical scanners (not shown).

Resource balancing and inferential service computing device 401 may operate in a networked environment supporting connections to one or more other computing devices, such as computing device 441 and 451. Computing devices 441 and 451 may be personal computing devices or servers that include any or all of the elements described above relative to resource balancing and inferential service computing device 401.

The network connections depicted in FIG. 4 may include Local Area Network (LAN) 425 and Wide Area Network (WAN) 429, as well as other networks. When used in a LAN networking environment, resource balancing and inferential service computing device 401 may be connected to LAN 425 through a network interface or adapter in communications module 409. When used in a WAN networking environment, resource balancing and inferential service computing device 401 may include a modem in communications module 409 or other means for establishing communications over WAN 429, such as network 431 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform, comprising:
at least one processor;
a communication interface communicatively coupled to the at least one processor; and
a memory storing computer-readable instructions that, when executed by the at least one processor, cause the computing platform to:
train a machine learning model to predict a type of computing system to process requests, wherein training the machine learning model includes training the model to identify, based on historical data related to request volume, number of active users, and frequency of requests, a type of computing system to process a request;
receive monitoring data, wherein the monitoring data includes current availability data of a plurality of computing resources associated with different types of computing systems;
receive a first request for processing, wherein the first request for processing includes parameters of the first request;
execute the machine learning model, wherein executing the machine learning model includes inputting the monitoring data of the plurality of computing resources and the parameters of the first request to output a particular type of computing system to process the first request;
determine, based on the received monitoring data, whether a delay exists in computing resources associated with the particular type of computing system output by the machine learning model;
responsive to determining that a delay does not exists, send the first request for processing to the computing resources associated with the particular type of computing system for processing;
responsive to determining that a delay does exist:
evaluate the delay to identify a cause of the delay;
identify, from historical data, a remediation action to address the cause of the delay;
automatically execute the remediation action to resolve the delay; and
send the first request for processing to the computing resources associated with the particular type of computing system for processing.

2. The computing platform of claim 1, wherein the particular type of computing system for processing the first request output by the machine learning model is one of: quantum computing, classical computing or hybrid computing.

3. The computing platform of claim 2, wherein processing the first request using hybrid computing includes processing a first portion of the first request using quantum computing techniques and a second portion of the first request using classical computing techniques.

4. The computing platform of claim 2, wherein the quantum computing includes photonic-based quantum computing hardware.

5. The computing platform of claim 1, further including instructions that, when executed, cause the computing platform to update the machine learning model based on processing the first request.

6. The computing platform of claim 1, wherein the monitoring data further includes current network status.

7. The computing platform of claim 1, wherein executing the machine learning model to output the particular type of computing system to process the first request includes analyzing a complexity of computations in the first request.

8. The computing platform of claim 1, wherein the identifying the remediation action to address the cause of the delay is performed using machine learning.

9. A method, comprising:
training, by a computing platform, the computing platform having at least one processor and memory, a machine learning model to predict a type of computing system to process requests, wherein training the machine learning model includes training the model to identify, based on historical data related to request volume, number of active users, and frequency of requests, a type of computing system to process a request;
receiving, by the at least one processor, monitoring data, wherein the monitoring data includes current availability data of a plurality of computing resources associated with different types of computing systems;
receiving, by the at least one processor, a first request for processing, wherein the first request for processing includes parameters of the first request;
executing, by the at least one processor, the machine learning model, wherein executing the machine learning model includes inputting the monitoring data of the plurality of computing resources and the parameters of the first request to output a particular type of computing system to process the first request;
determining, by the at least one processor and based on the received monitoring data, whether a delay exists in computing resources associated with the particular type of computing system output by the machine learning model;
based on determining that a delay does not exists, sending, by the at least one processor, the first request for processing to the computing resources associated with the particular type of computing system for processing;
based on determining that a delay does exist:
evaluating, by the at least one processor, the delay to identify a cause of the delay;
identifying, by the at least one processor and from historical data, a remediation action to address the cause of the delay;
automatically executing, by the at least one processor, the remediation action to resolve the delay; and
sending, by the at least one processor, the first request for processing to the computing resources associated with the particular type of computing system for processing.

10. The method of claim 9, wherein the particular type of computing system for processing the first request output by the machine learning model is one of: quantum computing, classical computing or hybrid computing.

11. The method of claim 10, wherein processing the first request using hybrid computing includes processing a first portion of the first request using quantum computing techniques and a second portion of the first request using classical computing techniques.

12. The method of claim 10, wherein the quantum computing includes photonic-based quantum computing hardware.

13. The method of claim 9, further including updating, by the at least one processor, the machine learning model based on processing the first request.

14. The method of claim 9, wherein the monitoring data further includes current network status.

15. The method of claim 9, wherein executing the machine learning model to output the particular type of computing system to process the first request includes analyzing a complexity of computations in the first request.

16. One or more non-transitory computer-readable media storing instructions that, when executed by a computing platform comprising at least one processor, memory, and a communication interface, cause the computing platform to:
train a machine learning model to predict a type of computing system to process requests, wherein training the machine learning model includes training the model to identify, based on historical data related to request volume, number of active users, and frequency of requests, a type of computing system to process a request;
receive monitoring data, wherein the monitoring data includes current availability data of a plurality of computing resources associated with different types of computing systems;
receive a first request for processing, wherein the first request for processing includes parameters of the first request;
execute the machine learning model, wherein executing the machine learning model includes inputting the monitoring data of the plurality of computing resources and the parameters of the first request to output a particular type of computing system to process the first request;
determine, based on the received monitoring data, whether a delay exists in computing resources associated with the particular type of computing system output by the machine learning model;
responsive to determining that a delay does not exists, send the first request for processing to the computing resources associated with the particular type of computing system for processing;
responsive to determining that a delay does exist:
evaluate the delay to identify a cause of the delay;
identify, from historical data, a remediation action to address the cause of the delay;
automatically execute the remediation action to resolve the delay; and
send the first request for processing to the computing resources associated with the particular type of computing system for processing.

17. The one or more non-transitory computer-readable media of claim 16, wherein the particular type of computing system for processing the first request output by the machine learning model is one of: quantum computing, classical computing or hybrid computing.

18. The one or more non-transitory computer-readable media of claim 17, wherein processing the first request using hybrid computing includes processing a first portion of the first request using quantum computing techniques and a second portion of the first request using classical computing techniques.

19. The one or more non-transitory computer-readable media of claim 17, wherein the quantum computing includes photonic-based quantum computing hardware.

20. The one or more non-transitory computer-readable media of claim 16, further including instructions that, when executed, cause the computing platform to update the machine learning model based on processing the first request.
